(19) United States
(12) Patent Application Publication
(10) Pub. No.: US 2018/0234376 A1
(43) Pub. Date: Aug. 16, 2018

(54) CONTENT BUNDLE CREATION

(71) Applicant: Microsoft Technology Licensing, LLC, Redmond, WA (US)

(72) Inventors: Linda Chen Gray, Kirkland, WA (US); Sherry Pei-chen Lin, Redmond, WA (US); Thomas Coolidge Stanton, Seattle, WA (US); Andrew James Peacock, Seattle, WA (US); Megan Marie Quintero, Seattle, WA (US)

(21) Appl. No.: 15/430,316

(22) Filed: Feb. 10, 2017

(51) Int. Cl. H04L 12/58; G06F 3/0486; G06F 3/0484

(52) U.S. Cl. CPC H04L 51/22; H04L 51/16; G06F 3/04842; G06F 3/0486; H04L 51/26

(57) ABSTRACT

Non-limiting examples of the present disclosure describe content bundle creation, where a user can create an exemplary bundle of content through an application/service. As an example, a bundle of content may be a bundle of emails created by a user through an exemplary email service. A first input may be received through a user interface of an email service. The first input associates a first email thread with one or more additional emails threads. A second input may be received through the user interface. The second input provides a tag to associate with the first email thread and the one or more additional email threads. An exemplary bundle of emails may be generated. The bundle of emails may comprise the first email thread, the one or more additional email threads and an association with the tag. The bundle of emails may be displayed inline in a mailbox of an email service.

### BACKGROUND

Currently, the only mechanisms available to a user to group together like content is through folder creation or through the creation of a label. In one instance, traditional email clients allow a user to create a folder and move content into the folder. However, this folder is outside the inbox, thus demoting the importance of said messages. Further, the folder structure is everlasting and remains a fixture in a navigational pane of an email client, which can clog up a mailbox of a user. Folder structures can also complicate a user interface of an email client, especially when users access an email client through a mobile device, which has limited display space. Furthermore, limitations with folder structures exist when there are other users that content is to be shared with. With folder structures, the other users are required to manually access a folder and do not receive automatic content updates. In alternative instances a label can be created for management of content. However, labels work like folders and have the same issues as described above. Labels are not ephemeral, have sharing limitations and have the potential to clog up the user interface and mailbox history of an email client.

As such, examples of the present application are directed to the general technical environment related to improving operation of an email service, where processing efficiency and usability are improved, among technical benefits.

### SUMMARY

Non-limiting examples of the present disclosure describe content bundle creation, where a user can create an exemplary bundle of content through an application/service. As an example, a bundle of content may be a bundle of emails created by a user through an exemplary email service. A first input may be received through a user interface of an email service. The first input associates a first email thread with one or more additional emails threads. A second input may be received through the user interface. The second input provides a tag to associate with the first email thread and the one or more additional email threads. An exemplary bundle of emails may be generated. The bundle of emails may comprise the first email thread, the one or more additional email threads and an association with the tag. The bundle of emails may be displayed inline in a mailbox of an email service.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Non-limiting and non-exhaustive examples are described with reference to the following figures.

FIG. 1 illustrates an exemplary system implementable on one or more computing devices on which aspects of the present disclosure may be practiced.

FIG. 2 is an exemplary method related to content bundle creation with which aspects of the present disclosure may be practiced.

FIGS. 3A-3D provide user interface views illustrating user interface examples for managing bundling of emails in an email service, with which aspects of the present disclosure may be practiced.

FIG. 4 is a block diagram illustrating an example of a computing device with which aspects of the present disclosure may be practiced.

FIGS. 5A and 5B are simplified block diagrams of a mobile computing device with which aspects of the present disclosure may be practiced.

FIG. 6 is a simplified block diagram of a distributed computing system in which aspects of the present disclosure may be practiced.

### DETAILED DESCRIPTION

Non-limiting examples of the present disclosure describe content bundle creation, where a user can create an exemplary bundle of content through an application/service. As an example, an exemplary bundle of content may be a bundle of emails associated with an email service. Exemplary bundles of content provide an alternative solution to folder/label solutions, where bundles of content are ephemeral in nature and can be presented inline with other content (e.g. email content) of an application/service (e.g. email service). While examples herein relate to creation of bundled content from an application/service, it is to be understood that examples described herein may extend to any aspect for management of bundled content including but not limited to: user-creation of a bundle of content, sharing of a created bundle of content, automatic generation (e.g. auto-bundling) of content on behalf of a user, enhanced search and filtering functionality for content (including bundled content) and generation of rich content previews for bundles of content. Other aspects related to management of bundled content may be provided in related co-pending applications.

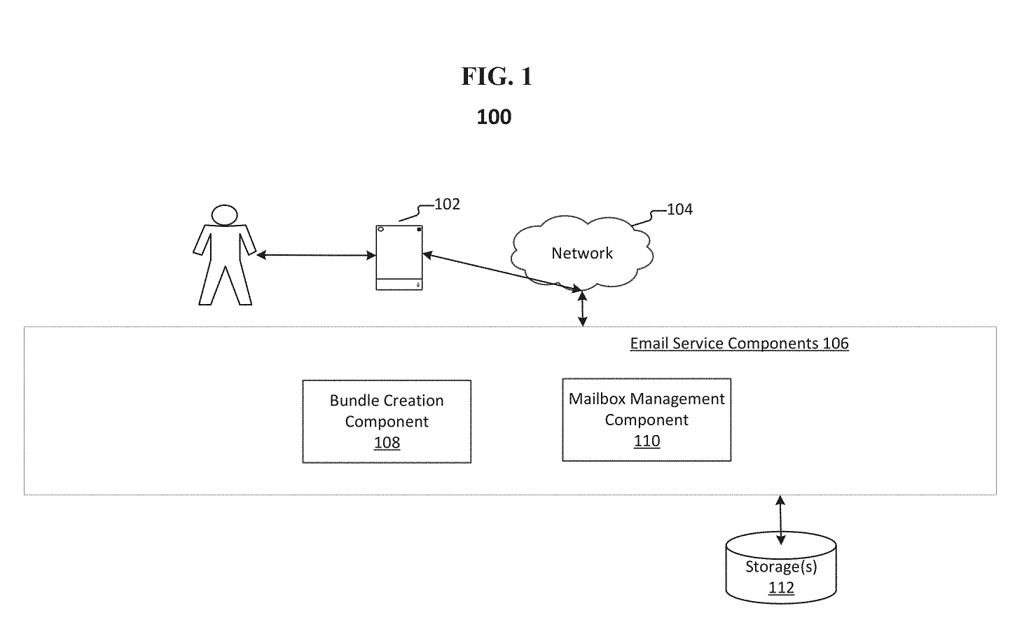

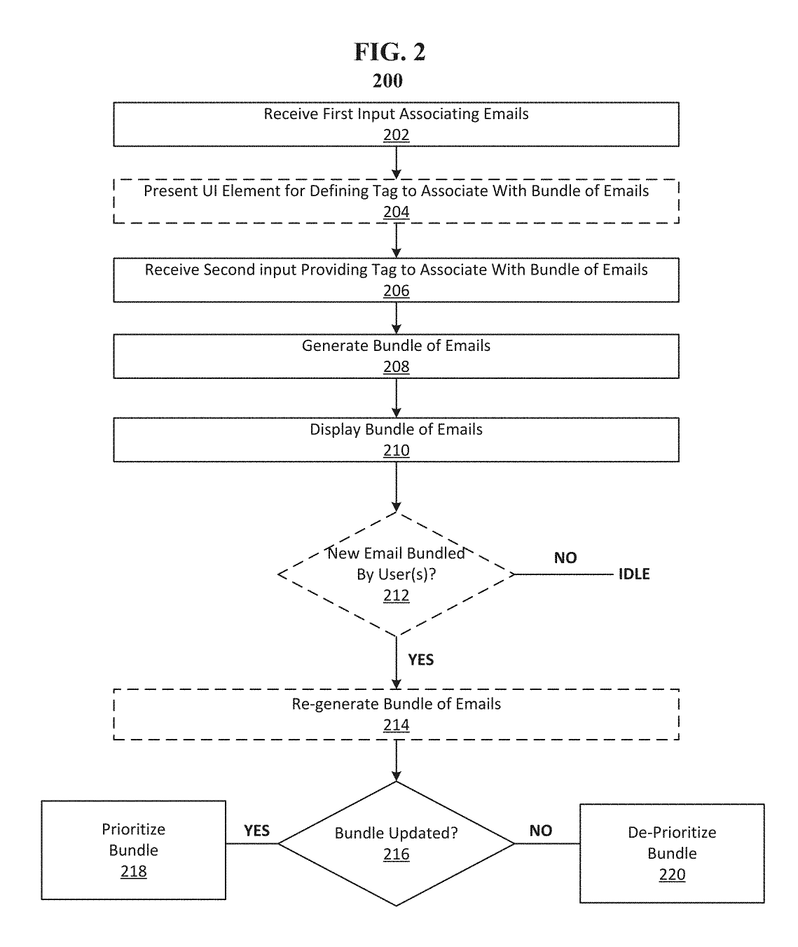

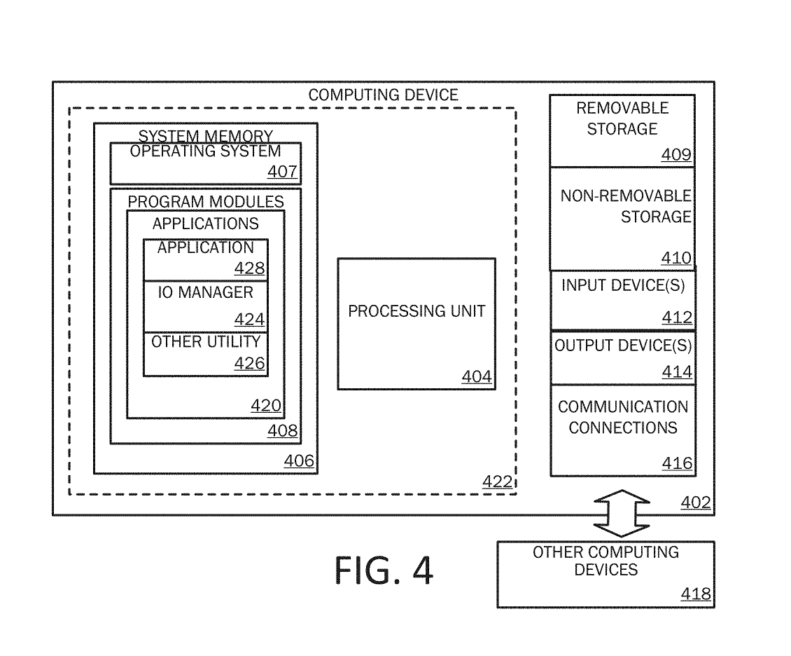

FIG. 1 illustrates an exemplary system 100 implementable on one or more computing devices on which aspects of the present disclosure may be practiced. System 100 may be an exemplary system for execution of an email service with which aspects of the present disclosure may be practiced. As an example, one or more components for managing creation of a bundle of content may interface with one or more other components of an email service. Components of system 100 may be hardware components or software implemented on and/or executed by hardware components. In examples, system 100 may include any of hardware components (e.g., ASIC, other devices used to execute/run an OS, and software components (e.g., applications, application programming interfaces, modules, virtual machines, runtime libraries) running on hardware. In one example, an exemplary system 100 may provide an environment for software components to run, obey constraints set for operating, and makes use of resources or facilities of the systems/processing devices, where components may be software (e.g., application, program, module) running on one or more processing devices. For instance, software (e.g., applications, operational instructions, modules) may be executed on a processing device such as a computer, mobile device (e.g., smartphone/phone, tablet) and/or any other type of electronic devices. As an example of a processing device operating environment, refer to operating environments of FIGS. 4-6. One or more components of system 100 may be configured to execute any of the processing operations described in at least method 200 described in the description of FIG. 2. In other examples, the components of systems disclosed herein may be spread across multiple devices. Exemplary system 100 comprises email service components 106 that further comprise: a bundle creation component 108 and a mailbox management component 110.

One or more data stores/storages or other memory may be associated with system 100. For example, a component of system 100 may have one or more data storage(s) 112 (described below) associated therewith. Data associated with a component of system 100 may be stored thereon as well as processing operations/instructions executed by a component of system 100. Furthermore, it is presented that application components of system 100 may interface with other application services. Application services may be provided as platform resources referenced in the foregoing. Application services may be any resource that may extend functionality of one or more components of system 100. Application services may include but are not limited to: personal intelligent assistant services, web search services, e-mail applications, word processing applications, spreadsheet applications, presentation applications, notes applications, calendaring applications, device management services, address book services, informational services, line-of-business (LOB) management services, customer relationship management (CRM) services, debugging services, accounting services, payroll services and services and/or websites that are hosted or controlled by third parties, among other examples. Application services may further include other websites and/or applications hosted by third parties such as social media websites; photo sharing websites; video and music streaming websites; search engine websites; sports, news or entertainment websites, and the like. Application services may further provide analytics, data compilation and/or storage service, etc., in association with components of system 100.

System 100 may comprise one or more storage(s) 112 that may store data associated with operation of one or more components of system 100. In examples, storage(s) 112 may interface with other components of system 100. Data associated with any component of system 100 may be stored in storage(s) 112, where components may be connected to storage(s) 112 over a distributed network including cloud computing platforms and infrastructure services. Exemplary storage(s) 112 may be any of a first-party source, a second-party source, and a third-party source. Storage(s) 112 are any physical or virtual memory space. Storage(s) 112 may store any data for processing operations performed by components of system 100, retained data from processing operations, stored programs, code or application programming interfaces (APIs), training data, links to resources internal and external to system 100 and knowledge data among other examples. Furthermore, in examples, components of system 100 may utilize knowledge data in processing by components of system 100. Knowledge may be used by one or more components of system 100 to improve processing of any of the email service components 106 where knowledge data can be obtained from resources internal or external to system 100. In examples, knowledge data may be maintained in storage(s) 112 or retrieved from one or more resources external to system 100 by knowledge fetch operation.

In FIG. 1, processing device 102 may be any device comprising at least one processor and at least one memory/storage. Examples of processing device 102 may include but are not limited to: processing devices such as desktop computers, servers, phones, tablets, phablets, slates, laptops, watches, and any other collection of electrical components such as devices having one or more processors or circuits. In one example processing device 102 may be a device of a user that is executing applications/services such as an exemplary email service (e.g. email client). An example of an email service is Outlook®. In examples, processing device 102 may communicate with the email service components 106 via a network 104. In one aspect, network 104 is a distributed computing network, such as the Internet. Email service components 106 may also communicate with application services via the network 104. Processing device 102 may be a device as described in the description of FIGS. 4-6. In some examples, processing device 102 may comprise multiple connected devices. Processing device 102 is an example of a user computing device.

The processing device 102 may execute processing operations that include an ability to access an application/service through a user account. In one example, processing device 102 may connect an authenticated user to an exemplary application/service that stores user data for one or more users of the application/service. For example, a user, utilizing processing device 102, may access an email service, where the email service may authenticate a user account of the user. The email service may access a mailbox management component 110 (of the email service components 106) to provide, to the processing device 102, a representation of a mailbox (of the email service) that is associated with the user account of the user.

An exemplary storage application/service may provide a user of processing device 102 with access to data stored in an exemplary data center. In one example, processing device 102 may be connected with storage(s) 112 via a distributed network, which may provide users with access to user data. One or more tenant resources (e.g. Tenant Resource A, Tenant Resource B, Tenant Resource C, etc.) may be associated with processing device 102. A tenant resource may be a user account associated with a processing device and/or distributed network service. Data associated with a tenant resource may be stored on storage(s) 112, where a tenant account can be utilized to access stored data by processing device 102 and/or other processing devices. Email service components 106 are components configured to execute processing operations to enable creation, sharing and management of a bundle of emails within an exemplary email service that is executing on client computing device 102. While examples described herein reference bundling of emails in an email service, it is to be understood that examples described herein are not limited to bundling of emails (of an email service) and may extend to any type of data bundling that can be used to replace folders/labels for bundling data for a service. The email service components 106 are executed by one or more computing devices. An exemplary computing device may comprise one or more processors and memory, among other components. Examples of computing devices are provided in the description of at least FIGS. 4-6. As referenced above, the email service components 106 comprise: a bundle creation component 108 and a mailbox management component 110.

The bundle creation component 108 is configured to enable user to create, customize and manage an exemplary bundle. Custom bundles (e.g. bundles of emails) are a light-weight mechanism for managing associations between content (e.g. emails where a bundle of emails may be created). A bundle can be defined as an automatic of manually set grouping of like items. As an example, a bundle may be created to group two or more email messages of an email service, creating a bundle of emails. An exemplary bundle of emails may comprise a grouping of at least two separate email threads. The bundle of emails may further comprise an exemplary tag, providing an association to an entity type tagging structure. An exemplary entity type tagging structure can be utilized to classify emails of an email service including bundled emails. Data associated with the entity type tagging structure (including an exemplary tag) is further used to assist with searching and filtering of email data including bundles of emails that are provided through an email service.

An exemplary tag is used to associate email messages and content of the bundle (e.g. bundle of emails). The tag associates an email message (and/or other content) with one or more additional email (and/or other content). In one example, an exemplary tag is a hashtag. However, tags are not limited to such a form. Created tags become entity values that can be used to efficiently associate emails of a bundle. Tags further become entity data that can be used to prioritize searching and retrieval of created bundles. In some instances, tags may remain associated with a bundle even when a message is separated from a bundle. This may assist users with being able to quickly relocate an email during a subsequent search. In alternative examples, an email that was previously associated with a bundle and later removed may not retain an association to an exemplary tag.

A bundle of emails is tagged with the bundle name/tag ID as part of an entity type tagging infrastructure. In one example, an entity type tagging infrastructure may be used for the assignment and management of tags associated with bundles of emails. That is, an entity type tagging structure may be generated for specific emails included in a bundle of emails. The entity type tagging structure may comprise a plurality of fields that are configured by developers, where data of the entity type tagging infrastructure can be utilized for management of content associated with a bundle including searching and filtering of bundles of content and sharing of bundled content. Attributes and fields associated with an exemplary entity type tagging infrastructure may vary based on the type of email content. In further examples, an entity type tagging infrastructure may be used for classification of any type of emails including emails not included in a bundle of emails as data from an entity type tagging infrastructure may be utilized to increase accuracy in classifying emails as a specific type or category. An exemplary categorization for a bundle of emails may be useful for back-end processing performed by the email service including: analysis of the bundle of emails (including content of the bundle of emails), generation of a representation of an exemplary mailbox, generation of recommendations/suggestions for a user, telemetry analysis for the email service and/or other associated applications/services, and other aspects of management of bundled content (e.g. sharing, searching/filtering, generation of rich content previews, etc.) among other examples. Examples of data fields that may be included in an exemplary entity type tagging infrastructure comprise but are not limited to: context fields pertaining to specific data of an email, tag/hashtag fields, email type fields, category fields, entity data fields, data source fields, date/timestamp information, hyperlink data fields, domain information fields, formatting/arrangement fields, confidence scores pertaining to classification and specific attributes of an email, data pertaining to specific email content and user triage action history with respect to specific messages (e.g. emails) and/or a category/type for the specific message, among other examples.

An exemplary bundle is contextually relevant and presented inline with other emails of a user mailbox. An email service is configured to create bundles of content on behalf of a user based on meaningful categories for the user/groups of users. This is a better solution than folders, labels or setting of email rules because a created bundle is ephemeral in nature. Bookmarked links such as folders/labels are not required to be created within a navigational pane of a user interface of an email service. Further, bundled content is automatically updated and intelligently managed by an email service, where bundled content can be automatically updated based on changes to message content associated with a user mailbox. If the topic item becomes irrelevant, a bundle would drop off (e.g. de-prioritize), but the bundle structure would still remain intact allowing for a bundle to be found later without requiring a physical link to be created and managed within a navigational pane of an email service (i.e. as with folders/labels). If a bundle receives a new message or update that may be relevant to a user (e.g. meeting appointment, tracking of shipment, notification, etc.), the bundle would be prioritized in a mailbox of a user. Notably, once a bundle is created in an email service, subsequent email messages from bundled message threads may result in update to the created bundle, where a user would not have to go looking for individual messages/message threads.

Additionally, an exemplary bundle of content may inherit all (or some) of the triage actions and behaviors associated with a single message. That is, an email service is configured to enable a user to execute bulk actions with respect to a bundle of content (e.g. bundle of emails). For instance, a user can delete a bundle of emails without being required to go in and execute actions on specific emails.

Consider an example where a user is attempting to management content associated with a house renovation. A user can create a content bundle entitled “House Reno” and place emails relating to the renovation of their home into a bundle of emails. As an example, an exemplary tag of “House Reno” may be created and associated with all content that is part of the bundle. For instance, a user may receive emails from different contractors and want to associate all received emails in one grouping without having to continually go searching for each individual email. Notably, once a bundle is created in an email service, subsequent email messages from bundled message threads may result in update to the created bundle, where a user would not have to go looking for individual messages/message threads from different contractors.

Further, an email service may be configured to evaluate new email messages/content to determine whether a bundle should be updated. For example, the bundle creation component 108 is configured to implement a bundling model (e.g. machine learning model) that can evaluate message content based on attributes of a created bundle to determine whether received emails (that may not be associated with a bundle) should be added to the bundle. Examples of attributes that may be evaluated by an exemplary bundling model comprise but are not limited to: sender domains associated with a bundle, other email recipients associated with bundled emails, email subject, keywords, references to specific content within bundled emails, categories/topics, exemplary tags, meeting invites/appointments, attachments, and flags/importance, among other examples. In analyzing such data, the bundling model collect, parsed and evaluate data in any form including: client side metrics associated with an emails service, user signal data (e.g. user usage history of the email service), server-side metrics as well as metrics related to cross-application usage (e.g. other applications/services associated with a user account that is accessing an email service). This enables the bundle creation component 108 to make a relevancy determination as to whether an email may be relevant to a bundle of emails.

In the example described above (e.g. “House Reno” bundle), an email message from a different contractor may be received that is not initially associated with the “House Reno” bundle. The bundle creation component 108 may apply an exemplary bundling model to determine whether to automatically include the new email in the bundle or provide a suggestion to the user to bundle. The bundle creation component 108 is further configured to easily enable a user to add new content to a created bundle. For instance, the new email from the contractor will show up in the inbox of the user, where the user, through an improved UI of the email service, can associate the new email with the created bundle. Examples for bundle creation and associating new content with a created bundle are subsequently described. In one instance, a user can drag and drop the email from the new contractor onto a created bundle to quickly and efficiently associate the new email with the bundle.

Furthermore, an exemplary bundle is configured to manage associations with other application/services such as platform resources that may comprise a suite of different applications. For instance, a user may have a calendared appoint setup with a specific contractor. Notifications and alerts associated with such content may presented to the user in conjunction with a created bundle. Subsequently described example refer to a rich content preview for the bundle, that is configured to provide, from a bundle of emails, information that is most relevant to the user. In one example, a rich content preview may comprise an indication of an upcoming calendared appointment with a specific contractor to pick out flooring for a kitchen. The rich content preview may further comprise links, images, information related to flooring options suggested in an email (of the bundle) by the contractor. The email service, through one or more of the email service components 106, may be configured to update rich content previews over time in a way that the previews are most relevant to a user or group of users.

Continuing the above “House Reno” example, once the house renovation project is over and the user ceases receiving new mails that would go into this bundle, the bundle falls below the fold, out of sight and out of mind. However, if for any reason the user later needs to reference an email in this bundle, a search will return all emails pertaining to this bundle. If a new email associated with the bundle is received at a later point in time, the bundle may be prioritized for the user in a mailbox of the user. For instance, a contractor may be late sending a receipt (e.g. 6 months or a year later), where the email service is configured to prioritize the bundle of emails when that receipt is received. If the user's attention moves on to another project the constitutes a bundle, this bundle is now at the top of the inbox and the other older bundles fall off and do not clog the navigational control of the email service. A user would not be required to manually remove folders/labels from the UI of the email service after the fact. As one example, the ephemeral nature of an exemplary bundle is extremely beneficial to workers/groups that change projects every couple months. Instead of having a massive list of hundreds of folders the represent the past projects, this user can have a clean and easy way to organize their content.

As described above, the bundle creation component 108 is configured to enable a user to create an exemplary bundle. A bundle may be created by a user of an email service, where the user is associated with a user account (e.g. for the email service or a universal account that enables a user to access a suite of platform resources that comprise a plurality of applications/services). A user interface (UI) of an exemplary email service is configured to enable users to create, share and management bundles of emails. An exemplary bundle of emails may be associated with one or more tags. For instance, tags can be user-created or created on behalf of a user by an exemplary email service. In one instance, a user can create a tag for a bundle to associate content. In one example, an email service UI provides one or more UI fields/features to enable a user to create a tag for a bundle of emails. In other examples, the email service is configured to automatically create and associate an exemplary tag with a bundle of emails on behalf of a user.

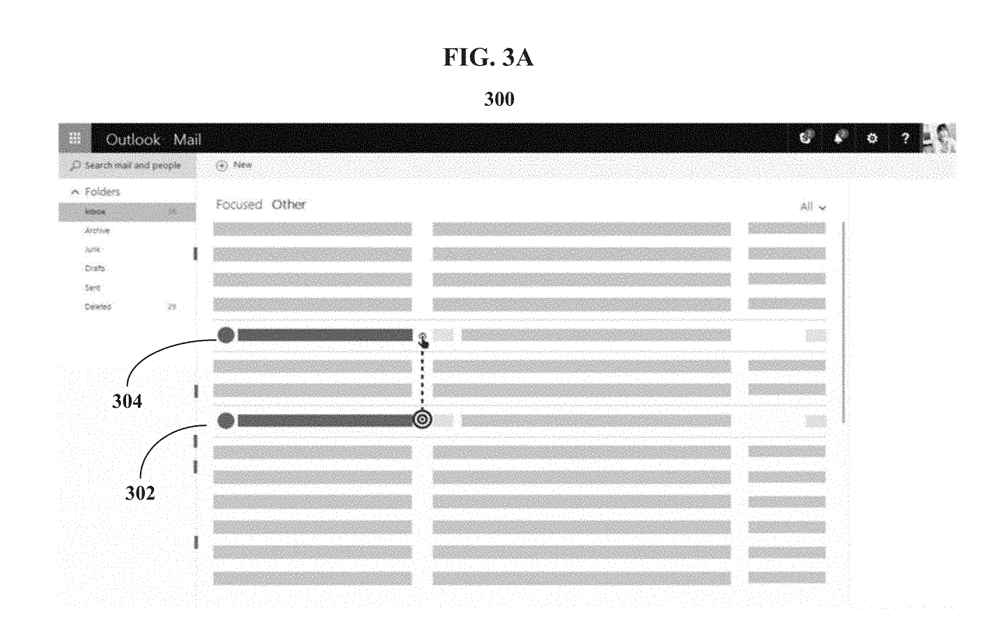

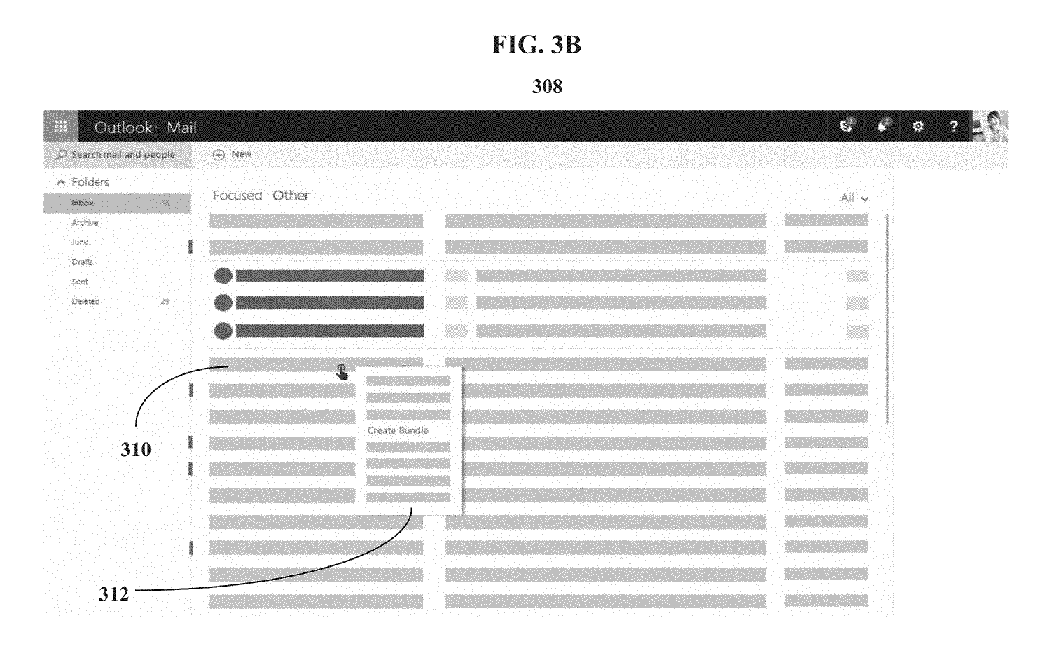

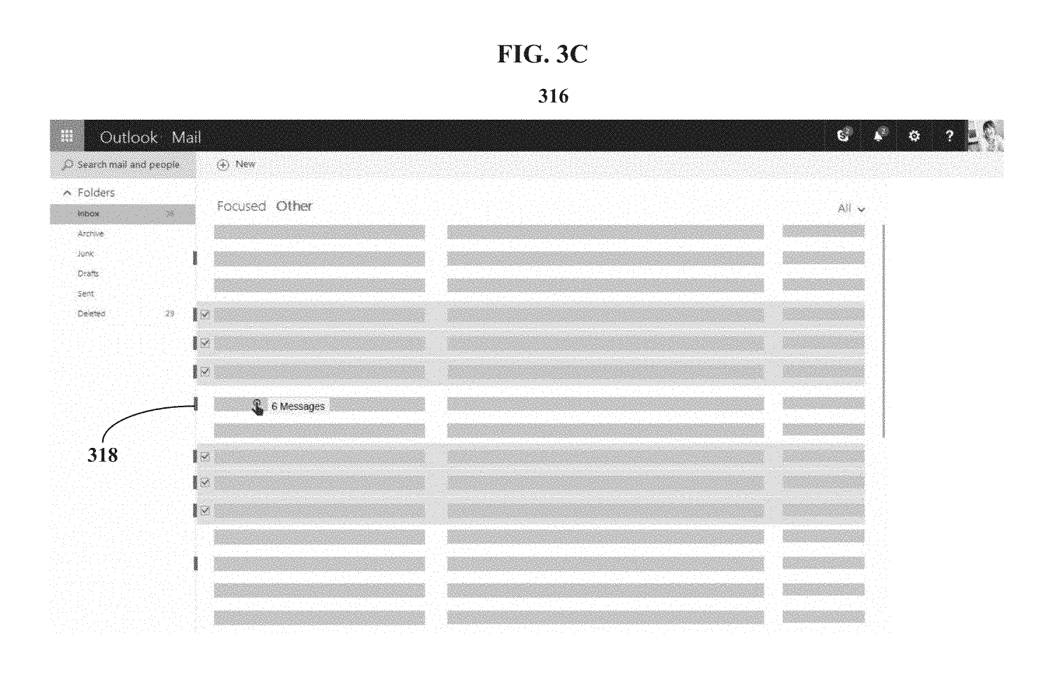

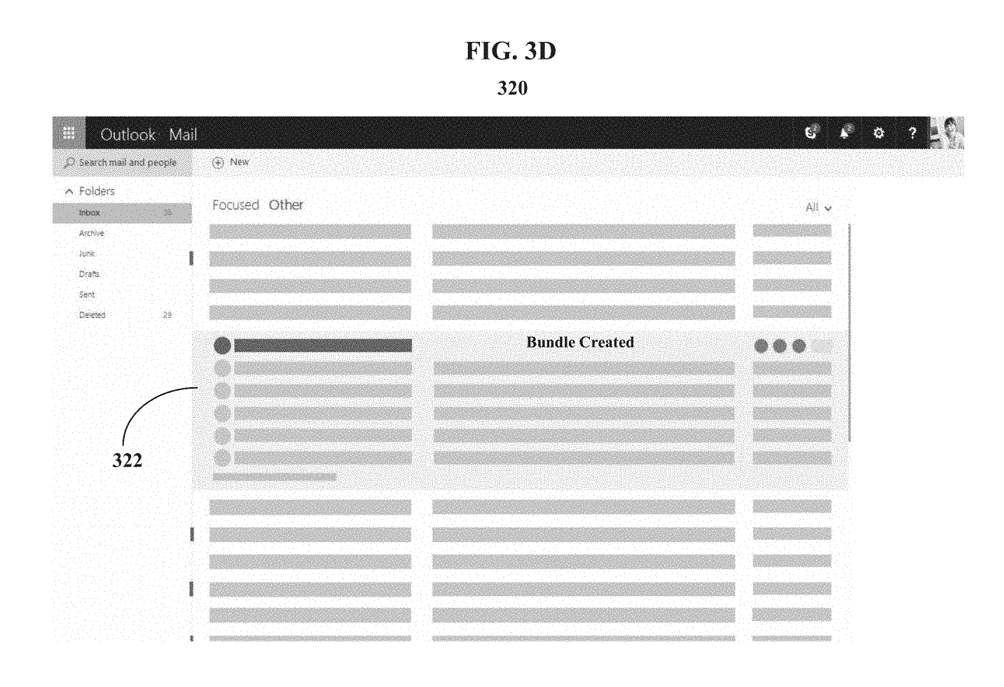

The bundle creation component 108 is configured to enable the user to create a bundle in a few different ways. Some UI examples for creation of a bundle of emails are provided in FIGS. 3A-3D. In one example, a bundle can be created through the context menus tied to a message (i.e. bundle emails of a specific type/category), by dragging an email onto another email. Such functionality is user-friendly and efficient from a processing standpoint, especially when users are working within a specific mailbox (e.g. inbox) of an email service. In an alternative example, a UI of an email service is configured with a UI feature (e.g. through a command bar/application command control) that enables a user to quickly access a feature for creation of a bundle of emails. In yet another alternative example, an exemplary email service is configured to enable a user to create a bundle of emails through device action (e.g. right click of mouse device, touch input, stylus input, etc.).

Created bundles may be displayed inline with other messages of a mailbox of a user. The UI of an exemplary email service is configured to enable the bundles to be presented in different states including but not limited to: a collapsed state, a rich content preview state, an expanded state (e.g. providing a partial view of content of a bundle) and a maximized state (e.g. where all content of a bundle is viewable). Further, users can perform bulk actions on the bundles, such as mark as read, delete, and pin. To open a bundle, the user clicks anywhere on the bundle item and the messages expand below. The user can then click on the messages to access a specific item. A UI of an email service may further be configured to enable a user to execute hover actions to view message content or execute actions at a message level. Given that only the top x messages in the bundle are shown on expand, the user can select “see more” and more messages are loaded. If the user still has not reached the message they desire, they can select a UI feature “see all” to view all message content of a bundle. On the collapsed bundle state, a summary is shown depicting the top unseen messages. An exemplary email service may be configured to vary a state of presentation of a bundle based upon attributes such read/unread messages and seen/unseen content. For instance, color, emphasis (e.g. bolding/flagging), associated notifications, prioritization in a mailbox, etc. may vary based on a collective state of a bundle of emails.

The mailbox management component 110 is a component configured to manage email data associated with a user account of an email service and provide a representation of a mailbox (of the email service) that is associated with the user account of the user. The mailbox management component 110 may retrieve email data associated with the user account and generate a representation of a mailbox for the user. An exemplary representation of the mailbox may be provided through an email service (e.g. executing on a processing device such as processing device 102). Generation of a representation of a mailbox of a user is known to one skilled in the art. Moreover, the mailbox management component 110 may interface with the bundle creation component 108 to enable the bundle creation component 108 to access email data (associated with a user account) for creation of bundled content. Data associated with a created bundle of content (e.g. bundle of emails) may be shared between components of an email service including the bundle creation component 108 and the mailbox management component 110. For instance, data associated with a created bundle of emails may be shared with the mailbox management component 110 to include the bundle of emails in a generated representation of a mailbox of the email service.

FIG. 2 is an exemplary method 200 related to content bundle creation with which aspects of the present disclosure may be practiced. As an example, method 200 may be executed by an exemplary processing device and/or system such as those shown in FIGS. 4-6. In examples, method 200 may execute on a device comprising at least one processor configured to store and execute operations, programs or instructions. Operations performed in method 200 may correspond to operations executed by a system and/or service that execute computer programs, application programming interfaces (APIs), neural networks or machine-learning processing, among other examples. As an example, processing operations executed in method 200 may be performed by one or more hardware components. In another example, processing operations executed in method 200 may be performed by one or more software components. In some examples, processing operations described in method 200 may be executed by one or more applications/services associated with a web service that has access to a plurality of application/services, devices, knowledge resources, etc. Processing operations described in method 200 may be implemented by one or more components connected over a distributed network, for example, as described in system 100 (of FIG. 1).

Method 200 begins at processing operation 202, where a first input is received through a user interface of an email service. The first input associates a first email thread with one or more additional email threads. The first input may be an input to initiate creation of a bundle of emails as described in the description of the bundle creation component 108 (of FIG. 1). In one example, the first input is a drag and drop action that comprises: a drag action of a first email and a drop action that drops the first email onto a second email that is included in the one or more additional email threads. Alternatively, the first input may be a selection of a user interface element, where the user interface element corresponds to a creation of the bundle of emails. Further examples for initiation of bundle creation are also described in the description of FIG. 1.

Flow may proceed to processing operation 204, where a user interface (UI) element is presented for a user to define an exemplary tag to associate with a bundle of emails. As an example, the UI element for defining an exemplary tag may be presented (processing operation 204) based on a receipt of the first input. As described in the foregoing, a user can create one or more tags for a bundle of emails. A user may enter an input into the UI element to define a tag for a bundle of emails. At processing operation 206, a second input may be received through the user interface where a user defines a tag to associate with the first email thread and the one or more additional email threads.

Flow may proceed to processing operation 208, where an exemplary bundle of emails may be generated. The bundle of emails may comprise the first email thread, the one or more additional email threads and an association with the tag. Additional attributes related to an exemplary bundle of emails are described in at least the foregoing description of FIG. 1. In one example, generation of a bundle of emails may further comprise: creating one or more additional tags for the bundle of emails based on an application of a machine learning model that analyzes metadata associated with the first email and the one or more additional emails. The one or more additional tags may be associated with the bundle of emails. Generation (processing operation 208) of an exemplary bundle of emails may further comprise assigning a categorization for the bundle of emails, where the categorization is used by the email service for classification of the bundle of emails as well as content associated with the bundle of emails. An exemplary categorization for a bundle of emails may be useful for back-end processing performed by the email service including: analysis of the bundle of emails (including content of the bundle of emails), generation of a representation of an exemplary mailbox, generation of recommendations/suggestions for a user, telemetry analysis for the email service and/or other associated applications/services, and other aspects of management of bundled content (e.g. sharing, searching/filtering, generation of rich content previews, etc.) among other examples.

A generated bundle of emails may be displayed (processing operation 210) in a mailbox of an email service. As an example, a mailbox may be an email inbox for a user account that is associated with an email service. However, generated bundles may be sent to/displayed in any type of mailbox associated with an email service. As an example, the bundle of emails may be displayed (processing operation 210) inline with other emails of an email inbox.

Processing of method 200 may proceed to decision operation 212, where it is determined whether new content (e.g. emails) is to be added to the bundle of emails by the user (e.g. bundle creator/bundle owner). If no new content is to added to a bundle by the user, flow branches NO and processing of method 200 remains idle until further action is to be taken with respect to a bundle (e.g. bundle to be updated/receives updated content). In cases where content is to be added to a bundle by a user, flow branches YES and proceeds to processing operation 214, where a bundle of emails may be re-generated. As an example, a user may provide input (e.g. third input) indicating to add a new email (or emails) to a bundle of emails triggering update to a bundle of emails. A re-generated bundle of emails may comprise: the first email thread, the one or more additional email threads, the new email(s), an association with the tag and an association with one or more additional tags generated based on an application of a machine learning model that analyzes metadata associated with emails of the re-generated bundle of emails.

Flow of method 200 may proceed to decision operation 216, where it is determined whether there is an update to the bundle of emails. Update to a bundle of emails may comprise additional content from message threads associated with bundled emails and changes to content provided by other users whom the bundle of emails is shared with, among other examples. In examples where an update occurs to a bundle of emails, flow branches YES and proceeds to processing operation 218. At processing operation 218, the bundle of emails is prioritized in a queue/message list of a user mailbox (of the email service). In examples where no update occurs to a bundle of emails, flow branches NO and proceeds to processing operation 220. At processing operation 220, the bundle of emails is de-prioritized in a queue/message list of a user mailbox (of the email service). Bundles of emails that do not receive updates can continue to be de-prioritized in a user mailbox. Anytime, an update is received, the bundle of emails can be immediately prioritized to the top of a user mailbox.

FIGS. 3A-3D provide user interface views illustrating user interface examples for managing bundling of emails in an email service, with which aspects of the present disclosure may be practiced. FIGS. 3A-3D provide visual examples that aim to enhance understanding of processing operations described herein such as those referenced in the description of FIGS. 1-2.

FIGS. 3A-3D provide user interface examples related to creation of an exemplary bundle by a user through a user interface of an email service. Creation of an exemplary bundle by a user is described in at least the description of the bundle creation component 108 of FIG. 1.

FIG. 3A illustrates user interface view 300, which provides a display of a user inbox of an exemplary email service. User interface view 300 illustrates a user action where a user is dragging and dropping a first email 302 onto a second email 304 to initiate creation of a bundle of emails. A user can continue to drag and drop emails on a created bundle to add content to the bundle. In alternative examples (not shown), drag and drop operations can also be used to remove content from a bundle of emails.

FIG. 3B illustrates user interface 308, which provides a display of a user inbox of an exemplary email service. User interface view 308 illustrates an alternative UI option for creation of a bundle of emails, where a user can select UI features associated with an email service to initiate creation of a bundle of emails. For example, a first email 310 may be selected, where a device action by the user may trigger display of a UI menu 312 that comprises a selectable option for creating an exemplary bundle of emails.

FIG. 3C illustrates user interface 316, which provides a display of a user inbox of an exemplary email service. User interface view 316 illustrates a result of selection of UI features for creation of a bundle, for example, from the UI menu 312 of FIG. 3B. A user may choose to create a bundle of emails through selection of a UI feature for bundle creation (e.g. through UI menu 312 or a command bar of the email service). An exemplary email service may direct a user to user interface view 316, where UI features 318 are presented for selection of specific emails to include in a created bundle. As an example, UI features 318 are selectable checkboxes that a user can utilize to highlight emails they wish to initially include in a created bundle. In at least one example, UI features 318 may appear next to all displayed emails to enable a user to select which emails they wish to include in a bundle. In an alternative example, UI features 318 may appear next to specific emails when a user selects (e.g. clicks on) specific emails. As can be seen in FIG. 3C, six emails are selected to be included in a created bundle of emails. Additional user interface features (not shown) may be presented to confirm that the selected emails are to be created as a bundle of emails.

FIG. 3D illustrates user interface 320, which provides a display of a user inbox of an exemplary email service. User interface view 320 illustrates a result of selection of UI features for creation of a bundle, for example, selection of UI features 318 of FIG. 3C. User interface 320 comprises an update to a mailbox of a user, where a bundle of emails 322 is created and displayed inline with other emails of the mailbox of the user. Continuing from the example provided in FIG. 3C, the bundle of emails 322 comprises a collection of six emails that were selected through UI features 318 (user interface view 316). A created bundle can be further modified/updated as described in the foregoing description.

FIGS. 4-6 and the associated descriptions provide a discussion of a variety of operating environments in which examples of the invention may be practiced. However, the devices and systems illustrated and discussed with respect to FIGS. 4-6 are for purposes of example and illustration and are not limiting of a vast number of computing device configurations that may be utilized for practicing examples of the invention, described herein.

FIG. 4 is a block diagram illustrating physical components of a computing device 402, for example a mobile processing device, with which examples of the present disclosure may be practiced. Among other examples, computing device 402 may be an exemplary computing device configured for execution of an email service as described herein. In a basic configuration, the computing device 402 may include at least one processing unit 404 and a system memory 406. Depending on the configuration and type of computing device, the system memory 406 may comprise, but is not limited to, volatile storage (e.g., random access memory), non-volatile storage (e.g., read-only memory), flash memory, or any combination of such memories. The system memory 406 may include an operating system 407 and one or more program modules 408 suitable for running software programs/modules 420 such as IO manager 424, other utility 426 and application 428. As examples, system memory 406 may store instructions for execution. Other examples of system memory 406 may store data associated with applications. The operating system 407, for example, may be suitable for controlling the operation of the computing device 402. Furthermore, examples of the invention may be practiced in conjunction with a graphics library, other operating systems, or any other application program and is not limited to any particular application or system. This basic configuration is illustrated in FIG. 4 by those components within a dashed line 422. The computing device 402 may have additional features or functionality. For example, the computing device 402 may also include additional data storage devices (removable and/or non-removable) such as, for example, magnetic disks, optical disks, or tape. Such additional storage is illustrated in FIG. 4 by a removable storage device 409 and a non-removable storage device 410.

As stated above, a number of program modules and data files may be stored in the system memory 406. While executing on the processing unit 404, program modules 408 (e.g., Input/Output (I/O) manager 424, other utility 426 and application 428) may perform processes including, but not limited to, one or more of the stages of the operations described throughout this disclosure. Other program modules that may be used in accordance with examples of the present invention may include electronic mail and contacts applications, word processing applications, spreadsheet applications, database applications, slide presentation applications, drawing or computer-aided application programs, photo editing applications, authoring applications, etc.

Furthermore, examples of the invention may be practiced in an electrical circuit comprising discrete electronic elements, packaged or integrated electronic chips containing logic gates, a circuit utilizing a microprocessor, or on a single chip containing electronic elements or microprocessors. For example, examples of the invention may be practiced via a system-on-a-chip (SOC) where each or many of the components illustrated in FIG. 4 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality described herein may be operated via application-specific logic integrated with other components of the computing device 402 on the single integrated circuit (chip). Examples of the present disclosure may also be practiced using other technologies capable of performing logical operations such as, for example, AND, OR, and NOT, including but not limited to mechanical, optical, fluidic, and quantum technologies. In addition, examples of the invention may be practiced within a general purpose computer or in any other circuits or systems.

The computing device 402 may also have one or more input device(s) 412 such as a keyboard, a mouse, a pen, a sound input device, a device for voice input/recognition, a touch input device, etc. The output device(s) 414 such as a display, speakers, a printer, etc. may also be included. The aforementioned devices are examples and others may be used. The computing device 404 may include one or more communication connections 416 allowing communications with other computing devices 418. Examples of suitable communication connections 416 include, but are not limited to, RF transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 406, the removable storage device 409, and the non-removable storage device 410 are all computer storage media examples (i.e., memory storage.) Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 402. Any such computer storage media may be part of the computing device 402. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

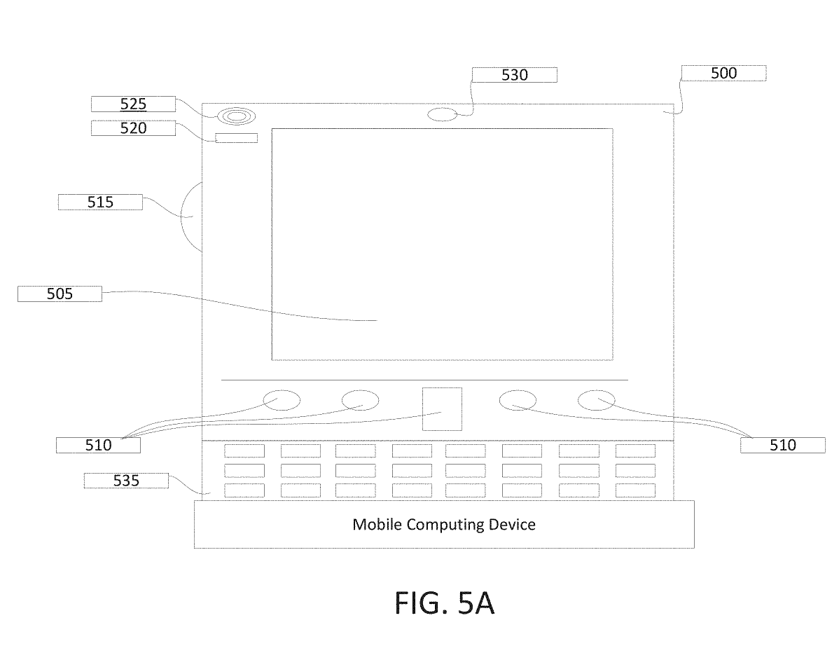

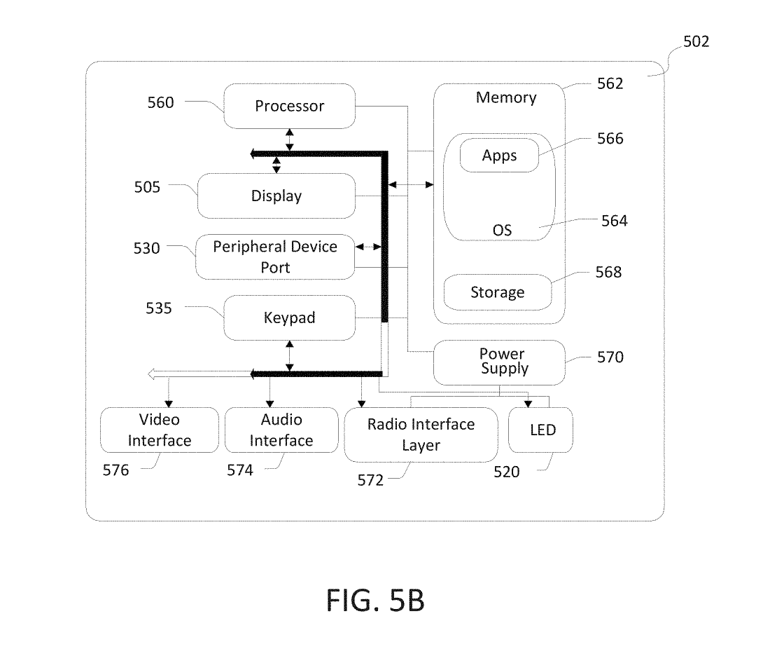

FIGS. 5A and 5B illustrate a mobile computing device 500, for example, a mobile telephone, a smart phone, a personal data assistant, a tablet personal computer, a phablet, a slate, a laptop computer, and the like, with which examples of the invention may be practiced. Mobile computing device 500 may be an exemplary computing device configured for execution of an email service as described herein. Application command control may be provided for applications executing on a computing device such as mobile computing device 500. Application command control relates to presentation and control of commands for use with an application through a user interface (UI) or graphical user interface (GUI). In one example, application command controls may be programmed specifically to work with a single application. In other examples, application command controls may be programmed to work across more than one application. With reference to FIG. 5A, one example of a mobile computing device 500 for implementing the examples is illustrated. In a basic configuration, the mobile computing device 500 is a handheld computer having both input elements and output elements. The mobile computing device 500 typically includes a display 505 and one or more input buttons 510 that allow the user to enter information into the mobile computing device 500. The display 505 of the mobile computing device 500 may also function as an input device (e.g., touch screen display). If included, an optional side input element 515 allows further user input. The side input element 515 may be a rotary switch, a button, or any other type of manual input element. In alternative examples, mobile computing device 500 may incorporate more or less input elements. For example, the display 505 may not be a touch screen in some examples. In yet another alternative example, the mobile computing device 500 is a portable phone system, such as a cellular phone. The mobile computing device 500 may also include an optional keypad 535. Optional keypad 535 may be a physical keypad or a “soft” keypad generated on the touch screen display or any other soft input panel (SIP). In various examples, the output elements include the display 505 for showing a GUI, a visual indicator 520 (e.g., a light emitting diode), and/or an audio transducer 525 (e.g., a speaker). In some examples, the mobile computing device 500 incorporates a vibration transducer for providing the user with tactile feedback. In yet another example, the mobile computing device 500 incorporates input and/or output ports, such as an audio input (e.g., a microphone jack), an audio output (e.g., a headphone jack), and a video output (e.g., a HDMI port) for sending signals to or receiving signals from an external device.

FIG. 5B is a block diagram illustrating the architecture of one example of a mobile computing device. That is, the mobile computing device 500 can incorporate a system (i.e., an architecture) 502 to implement some examples. In one examples, the system 502 is implemented as a “smart phone” capable of running one or more applications (e.g., browser, e-mail, calendaring, contact managers, messaging clients, games, and media clients/players). In some examples, the system 502 is integrated as a computing device, such as an integrated personal digital assistant (PDA), tablet and wireless phone.

One or more application programs 566 may be loaded into the memory 562 and run on or in association with the operating system 564. Examples of the application programs include phone dialer programs, e-mail programs, personal information management (PIM) programs, word processing programs, spreadsheet programs, Internet browser programs, messaging programs, and so forth. The system 502 also includes a non-volatile storage area 568 within the memory 562. The non-volatile storage area 568 may be used to store persistent information that should not be lost if the system 502 is powered down. The application programs 566 may use and store information in the non-volatile storage area 568, such as e-mail or other messages used by an e-mail application, and the like. A synchronization application (not shown) also resides on the system 502 and is programmed to interact with a corresponding synchronization application resident on a host computer to keep the information stored in the non-volatile storage area 568 synchronized with corresponding information stored at the host computer. As should be appreciated, other applications may be loaded into the memory 562 and run on the mobile computing device (e.g. system 502) described herein.

The system 502 has a power supply 570, which may be implemented as one or more batteries. The power supply 570 might further include an external power source, such as an AC adapter or a powered docking cradle that supplements or recharges the batteries.

The system 502 may include peripheral device port 530 that performs the function of facilitating connectivity between system 502 and one or more peripheral devices. Transmissions to and from the peripheral device port 530 are conducted under control of the operating system (OS) 564. In other words, communications received by the peripheral device port 530 may be disseminated to the application programs 566 via the operating system 564, and vice versa.

The system 502 may also include a radio interface layer 572 that performs the function of transmitting and receiving radio frequency communications. The radio interface layer 572 facilitates wireless connectivity between the system 502 and the “outside world,” via a communications carrier or service provider. Transmissions to and from the radio interface layer 572 are conducted under control of the operating system 564. In other words, communications received by the radio interface layer 572 may be disseminated to the application programs 566 via the operating system 564, and vice versa.

The visual indicator 520 may be used to provide visual notifications, and/or an audio interface 574 may be used for producing audible notifications via the audio transducer 525 (as described in the description of mobile computing device 500). In the illustrated example, the visual indicator 520 is a light emitting diode (LED) and the audio transducer 525 is a speaker. These devices may be directly coupled to the power supply 570 so that when activated, they remain on for a duration dictated by the notification mechanism even though the processor 560 and other components might shut down for conserving battery power. The LED may be programmed to remain on indefinitely until the user takes action to indicate the powered-on status of the device. The audio interface 574 is used to provide audible signals to and receive audible signals from the user. For example, in addition to being coupled to the audio transducer 525 (shown in FIG. 5A), the audio interface 574 may also be coupled to a microphone to receive audible input, such as to facilitate a telephone conversation. In accordance with examples of the present invention, the microphone may also serve as an audio sensor to facilitate control of notifications, as will be described below. The system 502 may further include a video interface 576 that enables an operation of an on-board camera 530 to record still images, video stream, and the like.

A mobile computing device 500 implementing the system 502 may have additional features or functionality. For example, the mobile computing device 500 may also include additional data storage devices (removable and/or non-removable) such as, magnetic disks, optical disks, or tape. Such additional storage is illustrated in FIG. 5B by the non-volatile storage area 568.

Data/information generated or captured by the mobile computing device 500 and stored via the system 502 may be stored locally on the mobile computing device 500, as described above, or the data may be stored on any number of storage media that may be accessed by the device via the radio 572 or via a wired connection between the mobile computing device 500 and a separate computing device associated with the mobile computing device 500, for example, a server computer in a distributed computing network, such as the Internet. As should be appreciated such data/information may be accessed via the mobile computing device 500 via the radio 572 or via a distributed computing network. Similarly, such data/information may be readily transferred between computing devices for storage and use according to well-known data/information transfer and storage means, including electronic mail and collaborative data/information sharing systems.

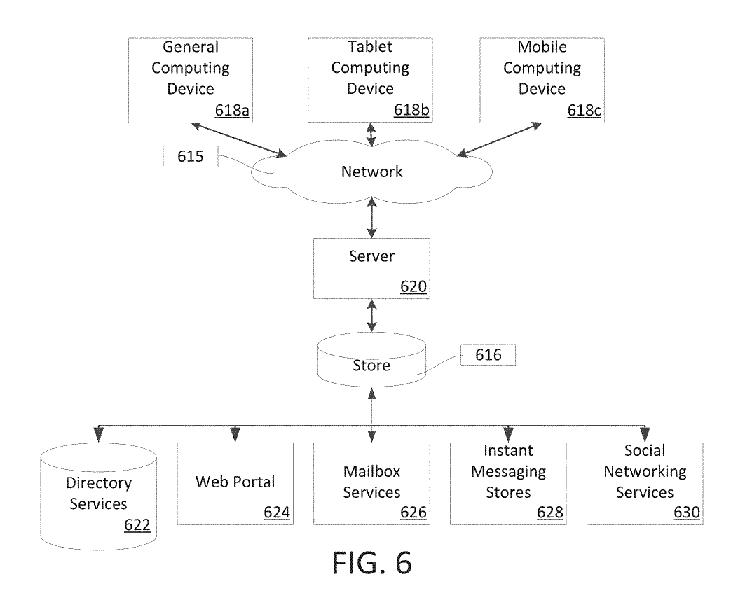

FIG. 6 illustrates one example of the architecture of a system for providing an application that reliably accesses target data on a storage system and handles communication failures to one or more client devices, as described above. The system of FIG. 6 may be an exemplary system configured for execution of an email service as described herein. Target data accessed, interacted with, or edited in association with programming modules 408 and/or applications 420 and storage/memory (described in FIG. 4) may be stored in different communication channels or other storage types. For example, various documents may be stored using a directory service 622, a web portal 624, a mailbox service 626, an instant messaging store 628, or a social networking site 630, application 428, I0 manager 424, other utility 426, and storage systems may use any of these types of systems or the like for enabling data utilization, as described herein. A server 620 may provide storage system for use by a client operating on general computing device 402 and mobile device(s) 500 through network 615. By way of example, network 615 may comprise the Internet or any other type of local or wide area network, and a client node may be implemented for connecting to network 615. Examples of a client node comprise but are not limited to: a computing device 402 embodied in a personal computer, a tablet computing device, and/or by a mobile computing device 500 (e.g., mobile processing device). As an example, a client node may connect to the network 615 using a wireless network connection (e.g. WiFi connection, Bluetooth, etc.). However, examples described herein may also extend to connecting to network 615 via a hardwire connection. Any of these examples of the client computing device 402 or 500 may obtain content from the store 616.

Reference has been made throughout this specification to “one example” or “an example,” meaning that a particular described feature, structure, or characteristic is included in at least one example. Thus, usage of such phrases may refer to more than just one example. Furthermore, the described features, structures, or characteristics may be combined in any suitable manner in one or more examples.

One skilled in the relevant art may recognize, however, that the examples may be practiced without one or more of the specific details, or with other methods, resources, materials, etc. In other instances, well known structures, resources, or operations have not been shown or described in detail merely to observe obscuring aspects of the examples.

While sample examples and applications have been illustrated and described, it is to be understood that the examples are not limited to the precise configuration and resources described above. Various modifications, changes, and variations apparent to those skilled in the art may be made in the arrangement, operation, and details of the methods and systems disclosed herein without departing from the scope of the claimed examples.

What is claimed is:

1. A method comprising:
receiving, through a user interface of an email service, first input to associate a first email thread with one or more additional email threads;
receiving, through the user interface, second input providing a tag to associate with the first email thread and the one or more additional threads;
generating a bundle of emails that comprises the first email thread, the one or more additional emails threads and an association with the tag; and
displaying, within an email inbox of the email service, the bundle of emails inline with other emails of the email inbox.

2. The method of claim 1, wherein the first input is a drag and drop action that comprises: a drag action of a first email and a drop action that drops the first email onto a second email that is included in the one or more additional emails threads.

3. The method of claim 1, wherein the first input is a selection of a user interface element, wherein the user interface element corresponds to a creation of the bundle of emails.

4. The method of claim 1, further comprising: presenting, based on a receipt of the first input, a user interface element for a user to define the tag.

5. The method of claim 1, wherein the generation of the bundle of email further comprises: creating one or more additional tags for the bundle of emails based on an application of a machine learning model that analyzes metadata associated with the first email thread and the one or more additional emails threads, and associating the one or more additional tags with the bundle of emails.

6. The method of claim 1, further comprising: receiving a new email associated with one or more emails of the bundle of emails, and prioritizing, within the email inbox, display of the bundle of emails based on a receipt of the new email.

7. The method of claim 1, further comprising: receiving a third input to add a new email to the bundle of emails, and re-generating the bundle of emails, wherein the re-generated bundle of emails comprises: the first email thread, the one or more additional emails threads, the new email, an association with the tag and an association with one or more additional tags generated based on an application of a machine learning model that analyzes metadata associated with emails of the re-generated bundle of emails.

8. The method of claim 1, further comprising: de-prioritizing, within the email inbox, display of the bundle of emails based on a receipt of one or more other emails in the email inbox.

9. A system comprising:
at least one processor; and
a memory operatively connected with the at least one processor storing computer-executable instructions that, when executed by the at least one processor, causes the at least one processor to execute a method that comprises:
receiving, through a user interface of an email service, first input to associate a first email thread with one or more additional email threads,
receiving, through the user interface, second input providing a tag to associate with the first email thread and the one or more additional threads,
generating a bundle of emails that comprises the first email thread, the one or more additional emails threads and an association with the tag, and
displaying, within an email inbox of the email service, the bundle of emails inline with other emails of the email inbox.

10. The system of claim 9, wherein the first input is a drag and drop action that comprises: a drag action of a first email and a drop action that drops the first email onto a second email that is included in the one or more additional emails threads.

11. The system of claim 9, wherein the first input is a selection of a user interface element, wherein the user interface element corresponds to a creation of the bundle of emails.

12. The system of claim 9, wherein the method, executed by the at least one processor, further comprises: presenting, based on a receipt of the first input, a user interface element for a user to define the tag.

13. The system of claim 9, wherein the generation of the bundle of email further comprises: creating one or more additional tags for the bundle of emails based on an application of a machine learning model that analyzes metadata associated with the first email thread and the one or more additional emails threads, and associating the one or more additional tags with the bundle of emails.

14. The system of claim 9, wherein the method, executed by the at least one processor, further comprises: receiving a new email associated with one or more emails of the bundle of emails, and prioritizing, within the email inbox, display of the bundle of emails based on a receipt of the new email.

15. The system of claim 9, wherein the method, executed by the at least one processor, further comprises: receiving a third input to add a new email to the bundle of emails, and re-generating the bundle of emails, wherein the re-generated bundle of emails comprises: the first email thread, the one or more additional emails threads, the new email, an association with the tag and an association with one or more additional tags generated based on an application of a machine learning model that analyzes metadata associated with emails of the re-generated bundle of emails.

16. The system of claim 9, wherein the method, executed by the at least one processor, further comprises: de-prioritizing, within the email inbox, display of the bundle of emails based on a receipt of one or more other emails in the email inbox.

17. A computer-readable medium storing computer-executable instructions that, when executed by at least one processor, causes the at least one processor to execute a method comprising:
receiving, through a user interface of an email service, first input to associate a first email thread with one or more additional email threads;
receiving, through the user interface, second input providing a tag to associate with the first email thread and the one or more additional threads;
generating a bundle of emails that comprises the first email thread, the one or more additional emails threads and an association with the tag; and
displaying, within an email inbox of the email service, the bundle of emails inline with other emails of the email inbox.

18. The computer-readable medium of claim 17, wherein the first input is a drag and drop action that comprises: a drag action of a first email and a drop action that drops the first email onto a second email that is included in the one or more additional email threads.

19. The computer-readable medium of claim 17, wherein the executed method further comprising: receiving a new email associated with one or more emails of the bundle of emails, and prioritizing, within the email inbox, display of the bundle of emails based on a receipt of the new email.

20. The computer-readable medium of claim 17, wherein the executed method further comprising: receiving a third input to add a new email to the bundle of emails, and re-generating the bundle of emails, wherein the re-generated bundle of emails comprises: the first email thread, the one or more additional emails threads, the new email, an association with the tag and an association with one or more additional tags generated based on an application of a machine learning model that analyzes metadata associated with emails of the re-generated bundle of emails.
